(19) United States
(12) Patent Application Publication
(10) Pub. No.: US 2006/0232494 A1
(43) Pub. Date: Oct. 19, 2006

(54) Automatic cross-display coordination

(75) Inventors: Arnold Lund, Sammimish, WA (US); Andrew Fuller, Redmond, WA (US); Matthew Rhoten, Kirkland, WA (US); Sriram Viji, Seattle, WA (US)

Correspondence Address: BANNER & WITCOFF LTD.,;ATTORNEYS FOR CLIENT NOS. 003797 & 013797, 1001 G STREET , N.W., SUITE 1100, WASHINGTON, DC, 20001-4597, US

(73) Assignee: Microsoft Corporation, Redmond, WA (US)

(21) Appl. No.: 11/108,162

(22) Filed: Apr. 15, 2005

(51) Int. Cl. G09G 5/00

(52) U.S. Cl. 345/1.1

(57) ABSTRACT

The invention relates to improved systems and methods for communicating information between an auxiliary display device and a primary display device. Methods and systems for automatic cross-display coordination between an auxiliary and primary display device through the use of executable command lines are provided. In at least one embodiment, a user of a user computer may determine what features of an application are associated with executable command lines and displayed on an auxiliary device. In yet other embodiments, an API is provided to allow a user to select or manually enter command lines to execute on a primary display device. Yet further aspects of the invention, the auxiliary display device is used to remotely produce a visual output on a primary display device.

### FIELD OF THE INVENTION

The invention relates generally to computer systems, and more particularly to improved systems and methods for communicating information between an auxiliary display device and a primary display device.

### BACKGROUND OF THE INVENTION

U.S. patent applications Ser. Nos. 10/429,930 and 10/429,932, incorporated herein by reference, are generally directed towards the concept of computer systems having auxiliary processing and auxiliary mechanisms that provide some auxiliary computing functionality. For example, a small LCD on the lid or side of a laptop computer can provide its owner with useful information, such as a meeting location and time, even when the main computer display is not easily visible, e.g., when a laptop computer's lid is closed and/or the main computer is powered down. Controls such as buttons may be provided to allow the user to interact with the auxiliary device to view different types of data, such as to scroll through appointments among calendar data, read email messages, read directions, and so forth.

While auxiliary displays may provide valuable information to a user, the user may wish to coordinate the information on the auxiliary display device with a primary display device. For example, a user of a laptop computer may receive information on an auxiliary display device that the user wishes to execute on a primary display. Often the computer will have to be removed from a low energy state to reinitiate the operating system (OS), and the user will have to manually execute a command line, select an icon, or otherwise execute an application to resume the function previously being performed on the auxiliary display. In other situations, the user may want to continue performing a task that cannot be initiated on the auxiliary display. Again, the user must expend valuable processing and power consumption on re-initiating all the open programs on a computer before executing the task. It goes from the following, therefore, there exists a need in the art for methods and apparatuses for cross-display coordination.

### SUMMARY OF THE INVENTION

The present invention teaches methods for communicating information between an auxiliary display device and a primary display device. Aspects of the invention disclose methods and systems for automatic cross-display coordination through the use of executable command lines. In at least one embodiment, a user of a user computer may determine what features of an application are associated with executable command lines. In yet other embodiments, an interface is provided to allow a user to select or manually enter command lines to execute on a primary display device. Yet further aspects of the invention, the auxiliary display device is used to remotely produce a visual output on a primary display device.

Other advantages will become apparent from the following detailed description when taken in conjunction with the drawings, in which:

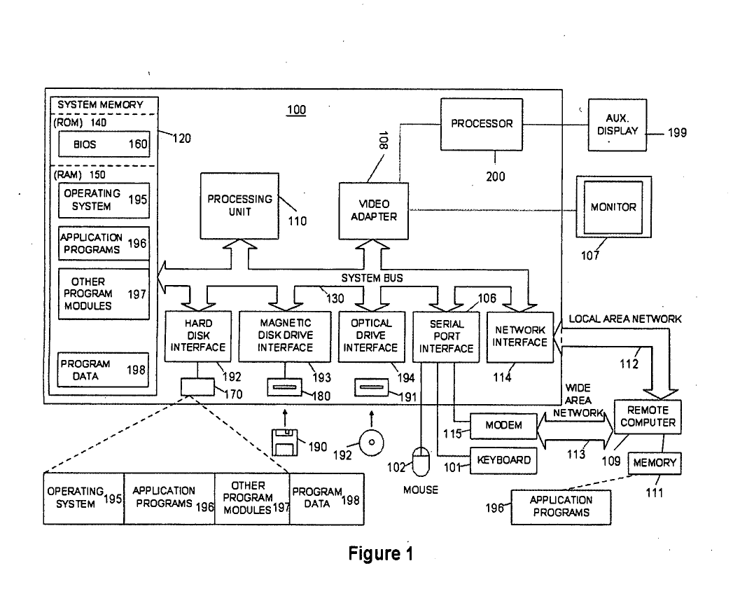

FIG. 1 is a functional block diagram of an example of a conventional general-purpose digital computing environment that an auxiliary display device may be used in conjunction with.

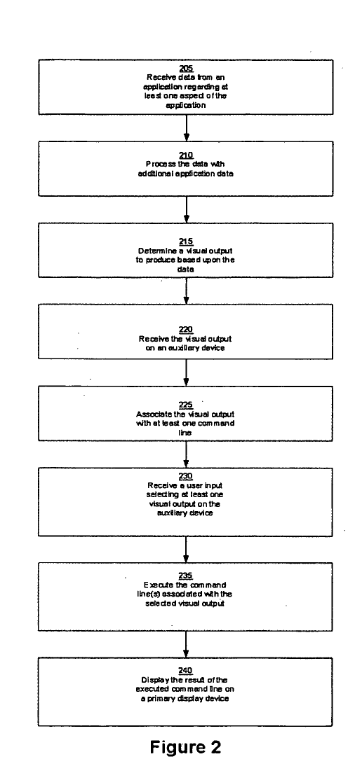

FIG. 2 illustrates one method of utilizing an auxiliary display device according to at least one embodiment of the present invention.

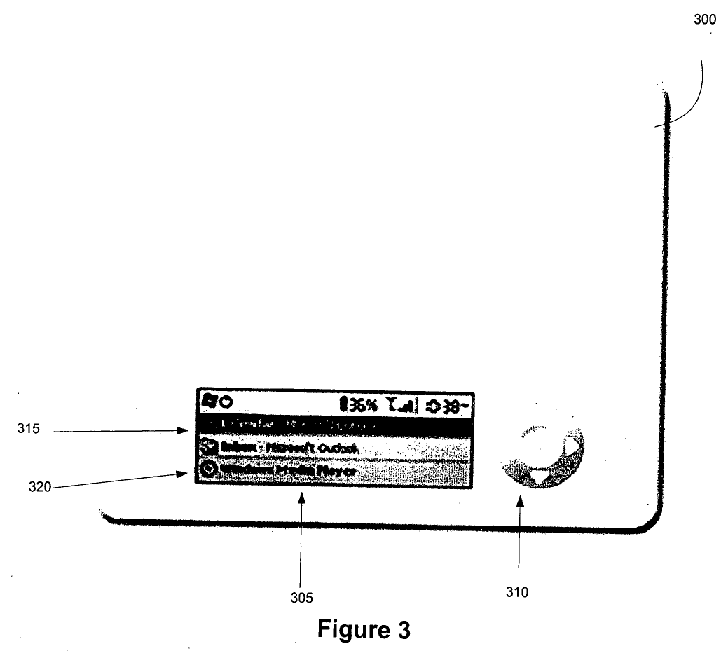

FIG. 3 illustrates a laptop computer having an exemplary auxiliary display according to one embodiment of the present invention.

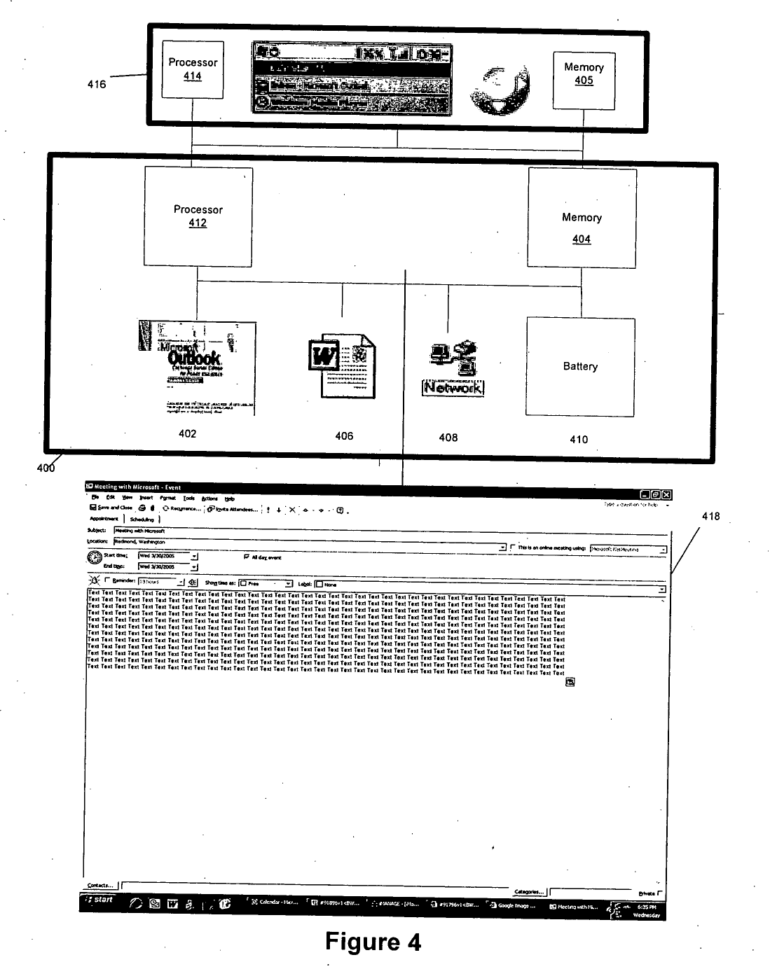

FIG. 4 is a functional block diagram of an example computer system according to one embodiment of the present invention.

### DETAILED DESCRIPTION OF THE INVENTION

Exemplary Operating Environment

FIG. 1 is a functional block diagram of an example of a conventional general-purpose digital computing environment that an auxiliary display device may be used in conjunction with. In FIG. 1, a computer 100 includes a processing unit 110, a system memory 120, and a system bus 130 that couples various system components including the system memory to the processing unit 110. The system bus 130 may be any of several types of bus structures including a memory bus or memory controller, a peripheral bus, and a local bus using any of a variety of bus architectures. The system memory 120 includes read only memory (ROM) 140 and random access memory (RAM) 150.

A basic input/output system 160 (BIOS), containing the basic routines that help to transfer information between elements within the computer 100, such as during start-up, is stored in the ROM 140. The computer 100 also includes a hard disk drive 170 for reading from and writing to a hard disk (not shown), a magnetic disk drive 180 for reading from or writing to a removable magnetic disk 190, and an optical disk drive 191 for reading from or writing to a removable optical disk 192 such as a CD ROM or other optical media. The hard disk drive 170, magnetic disk drive 180, and optical disk drive 191 are connected to the system bus 130 by a hard disk drive interface 192, a magnetic disk drive interface 193, and an optical disk drive interface 194, respectively. The drives and their associated computer-readable media provide nonvolatile storage of computer readable instructions, data structures, program modules and other data for the personal computer 100. It will be appreciated by those skilled in the art that other types of computer readable media that can store data that is accessible by a computer, such as magnetic cassettes, flash memory cards, digital video disks, Bernoulli cartridges, random access memories (RAMs), read only memories (ROMs), and the like, may also be used in the example operating environment.

A number of program modules can be stored on the hard disk drive 170, magnetic disk 190, optical disk 192, ROM 140 or RAM 150, including an operating system 195, one or more application programs 196, other program modules 197, and program data 198. A user can enter commands and information into the computer 100 through input devices such as a keyboard 101 and pointing device 102. Other input devices (not shown) may include a microphone, joystick, game pad, satellite dish, scanner or the like. These and other input devices are often connected to the processing unit 110 through a serial port interface 106 that is coupled to the system bus, but may be connected by other interfaces, such as a parallel port, game port or a universal serial bus (USB). Further still, these devices may be coupled directly to the system bus 130 via an appropriate interface (not shown). A monitor 107 or other type of display device is also connected to the system bus 130 via an interface, such as a video adapter 108. An auxiliary display device 199 may also be in communication with computer 100. The auxiliary device may be integrated within the computer (as shown), detachable, or external. The auxiliary display device 199 may optionally be in communication with an auxiliary processor 200,which may be integrated within the auxiliary display or housed within the computer 100. In addition to the monitor, personal computers typically include other peripheral output devices (not shown), such as speakers and printers.

The computer 100 can operate in a networked environment using logical connections to one or more remote computers, such as a remote computer 109. The remote computer 109 can be a server, a router, a network PC, a peer device or other common network node, and typically includes many or all of the elements described above relative to the computer 100, although only a memory storage device 111 has been illustrated in FIG. 1. The logical connections depicted in FIG. 1 include a local area network (LAN) 112 and a wide area network (WAN) 113. Such networking environments are commonplace in offices, enterprise-wide computer networks, intranets and the Internet.

When used in a LAN networking environment, the computer 100 is connected to the local network 112 through a network interface or adapter 114. When used in a WAN networking environment, the personal computer 100 typically includes a modem 115 or other means for establishing a communications over the wide area network 113, such as the Internet. The modem 115, which may be internal or external, is connected to the system bus 130 via the serial port interface 106. In a networked environment, program modules depicted relative to the personal computer 100, or portions thereof, may be stored in the remote memory storage device.

It will be appreciated that the network connections shown are illustrative and other techniques for establishing a communications link between the computers can be used.

The existence of any of various well-known protocols such as TCP/IP, Ethernet, FTP, HTTP, Bluetooth, IEEE 802.11x and the like is presumed, and the system can be operated in a client-server configuration to permit a user to retrieve web pages from a web-based server. Any of various conventional web browsers can be used to display and manipulate data on web pages.

### DESCRIPTION OF ILLUSTRATIVE EMBODIMENTS

FIG. 2 illustrates one method of utilizing an auxiliary display device according to at least one embodiment of the present invention. First looking to FIG. 2, step 205 illustrates data being received from at least one software or hardware application. The data may be received by the computer memory 120 or any other computer readable medium. In one embodiment, the data may comprise information relating to a plurality of aspects or features of a single software application. For example, as shown in FIG. 4, an exemplary user computer 400 having application 402 (Microsoft® Outlook®) installed or otherwise available may receive data at memory 404 or 405. The data may comprise information relating to a received e-mail message as well as additional information relating to an updated task or appointment within Outlook®. In yet other embodiments, the data comprises information relating to a plurality of different programs and/or hardware. If, for example, the user computer is a battery powered laptop, the received data may comprise information relating to the battery level and information relating to a new update or application being available, for example, a new template being available for a word processing application, such as Microsoft® Word®. Indeed, information received in step 205 and/or step 210 (discussed below) may be received from applications available through the wide area network 104 or other remote locations. In one embodiment, the available data that may be received in step 205 may be changed as new aspects or features are downloaded or otherwise available on the user computer.

In yet another embodiment, optional step 210 may further process information from two or more software or hardware applications, such as applications 406 and 408, to create data that is not available from each program individually. Using the previous embodiment as an example, data regarding the battery's (410) remaining power may be received along with information regarding the size of a Word® document template available for downloading from application 406. Step 210 may receive and further combine the information with additional information regarding the status of a network connection, such as through wide area network application 408, to create new data indicating the amount of time remaining that the word processing template can be downloaded before the battery dies. The information may be processed by processors 412 and/or 414.

In yet further embodiments, the user may customize the data to be received in steps 205 and/or 210. This would allow the user to receive information about applications without having to expend valuable processing and memory power. Furthermore, in at least one embodiment, the data received at steps 205 and/or 210 is independent from the state of the application the data relates to. For example, if the information relates a received e- mail, for example, in Microsoft® Outlook®, the information may be received at steps 205 and/or 210 regardless of whether Outlook® is fully loaded into a memory, such as memory 404.

The received data is then converted to a visual output and received at the auxiliary display device. (steps 215-220). As illustrated in FIG. 4, the visual output on the auxiliary display device 416 may be in the form of text, graphics, or a combination of graphics and text. Such graphical representations may be in the form of readily known icons having a plurality of attributes, wherein the attributes displayed on the auxiliary output may depend on the feature or aspect of the application being received. For example, it is customary in the computer related industries to provide a graphical output of an envelope to indicate a new e-mail message has been received. In one embodiment of the invention, the color attributes of a graphical envelope could be altered to indicate the urgency of the message. In yet another embodiment, the envelope could flash and/or appear larger to indicate the sender of the e-mail message. One skilled in the art will recognize there are a large number of attributes of an icon or graphical representations that may be altered to notify a user of aspects of an application, such as, for example, animation of the icon.

In yet further embodiments, a sound may be associated with a receiving an output at the auxiliary device. This would be especially advantageous where the auxiliary device is substantially smaller than the primary display, such as for example, when using a laptop form factor. This may be used to alert a user to look at the auxiliary display device. In at least one embodiment, the auxiliary display device is in communication with an auxiliary processor. This would be especially advantageous when a computer is in standby or hibernation mode and thus the main processor, such as 120, is not fully operational.

The data received at steps 205 and/or 210 is associated with at least one command line (step 225). For example, upon receiving a visual output at step 220 indicating a new e-mail has been received, step 225 may associate a command line that, when executed, would display or otherwise open the received e-mail message. The command line may be stored on memory 404 and/or 405 and executed with processor 412 and/or 414. In yet another embodiment, step 225 may associate a plurality of command lines with the visual output, allowing the user to select which command line to execute. For example, one command line may be executed to display the subject line or first few lines of the e-mail message within the auxiliary display, while another command line may be executed to open a reply message on a primary display device. In still yet another embodiment, a plurality of command lines may associated with the visual output that may be executed simultaneously. One exemplary command line may be written in DOS and resemble: C:\ProgramFiles\Microsoft Office\Outlook\MssgeID=134, wherein the received message is MssgeID134. While the exemplary command line is shown as a DOS prompt, any executable code in the art may be associated with the visual output displayed on the auxiliary display device. Furthermore, while the exemplary embodiment sends the command line after the information is already received at the display device, one skilled in the art will appreciate the command line may be associated with the displayed output before it is received at the auxiliary device, for example at step 205 and/or 210.

At step 230, an input is received from a user, the input selecting at least one graphical representation on the auxiliary display device associated with at least one command line. The input may be received through user control devices associated with the auxiliary display, such as for example, buttons or knobs, a pointing device, such as a stylus, or by use of a touch screen auxiliary display. Indeed, one skilled in the art will realize there are numerous methods to receive a user input. Yet in other embodiments, an input is not required before executing the associated command line. For example, a computer may be configured to execute the command line associated with the aspect of an application most recently viewed on the auxiliary display. For example, according to one embodiment, opening a laptop computer may immediately execute the command line. In yet other embodiments, the computer may be configured to automatically execute certain command lines. For example, a user may configure a computer to execute command lines to produce an output on a primary display upon receiving a new e-mail from a specific contact.

In one embodiment of the invention, the associated command line is immediately executed upon receiving a user input with the resulting output displayed on the primary display device, such as shown by visual output 418. In yet another embodiment, a plurality of inputs from the user may be stored in a memory, such as memory 404 or 405 until the primary display device is reactivated. This would be especially advantageous for laptop users, who generally prefer to preserve battery life. For example, laptops generally enter into a low-energy state, such as “standby” or “hibernation” mode after a period of inactivity. Upon entering standby mode, high energy-consuming devices, such as the primary display device are inactivated and the computer enters a low energy state to preserve battery life. Alternatively, the laptop may enter a hibernation mode. Upon entering hibernation, the computer “session” will be saved within the system memory 120, and the computer will shut down entirely. According to one embodiment, an auxiliary display device may remain active while the computer is in standby or hibernation mode, allowing the user to still receive data from applications and devices, such as those of steps 205 and 210, without having to consume large amounts of energy from the battery. In at least one embodiment, the auxiliary display device is in communication with an auxiliary processor and/or memory that is operational during hibernation. In such embodiments, the command line associated with the output displayed can be stored external to the main processor and thus executed while the computer is in hibernation. In one embodiment, a plurality of inputs from the user may be stored in an auxiliary memory until the primary display device is reactivated. For example, a user may use an auxiliary display device to select which specific e-mails or URLs to view and determine when to execute the associated command lines, thereby activating the computer to only execute those selected command lines.

FIG. 3 illustrates a laptop computer having an auxiliary display device according to one embodiments of the present invention. Laptop computer 300 has an auxiliary display device 305 positioned on an outer cover of the primary display device. The exemplary auxiliary display device 305 is associated with user controls 310 for scrolling and/or selecting the output displayed on the auxiliary display. As stated above, however, other user controls may be used to initiate a user input with an external device, such as a pointing device, or by use of a touch screen auxiliary display among other means known in the art.

The exemplary auxiliary display device 305 can convey a plurality of aspects of different applications to the user. For example, the auxiliary display 305 indicates the selection “Calendar-Microsoft Outlook” is highlighted (see 315). By using user controls 310, the user may select that the calendar be displayed on a primary display device. Yet in other embodiments, the user controls 305 may further allow the user to determine how the calendar is viewed before executing the appropriate command line, for example, a seven day or one month view. Yet in other embodiments, the user may use user controls 305 to initiate a new appointment in Microsoft® Outlook®. This selection may be performed in an auxiliary memory, such as memory 405 and transferred to the program at a later time, or the selection may immediately execute the command line on a primary display device.

An auxiliary processor and/or power supply may be associated with the auxiliary display 305. An auxiliary processor may be configured to process command lines associated with the selected displayed outputs on the auxiliary display 305. This would be advantageous when the computer device is in a low-energy state and the user does not desire to utilize the energy required for the system processor. In one embodiment, the auxiliary processor may have enough processing power to process the command line without utilizing the system processor 120. Using the exemplary illustration as an example, the auxiliary display device entry 320 indicates “Windows Media Player” is accessible, therefore, the user may listen to music within Media Center® without having to waste the energy to power the main processor 120. Indeed, the auxiliary display device can function as the user interface for internet radio, video, “push information”, MP3 player, or become the hardware equivalent of the Windows Media Player as described above. In yet other embodiments, it is advantageous to utilize a primary processor, such as processor 120, to execute the command line.

Furthermore, as the exemplary display device shows, the auxiliary display 305 may further include “non-selectable” information regarding the computer and available applications, for example, the time of day and the strength of a wireless connection signal. Further information that may be conveyed may include, but is not limited to, other information normally associated with the task bar, or “system tray” in an OS such as Win9x/NT or the like.

While the exemplary computer has the auxiliary device installed on the outer cover of the primary display device, the location is primarily for illustrative purposes. Indeed, it is contemplated by the present invention to have the auxiliary device anywhere that is accessible to a user. For example, the device may be plugged into any port, such as a parallel port, game port or a USB port. Indeed, it is conceivable to provide after market auxiliary display devices that may be plugged into existing computer devices. Indeed, a mobile telephone, a music playing device, a pocket-sized personal computer, a personal digital assistant or the like, may serve as an auxiliary device to a main computer system when coupled to it, such as physically and/or via a wireless link, (described below) or at any point after being coupled to the computer, if the device persists data from the computer, as long as the device is programmed to allow its display and/or other functionality to be leveraged by the main computer. In general, any device with I/O capabilities that can interface in virtually any way with a computer system can potentially serve as an auxiliary display device. Although computer 300 is illustrated as a laptop form factor, other form factors may be installed with an auxiliary device.

In yet other embodiments the auxiliary display device may be detachable from the laptop or computer and may include a rechargeable energy supply, such that the display device is recharged upon being “redocked” with computer 300. In still further embodiments, a detachable auxiliary device 305 may include a mechanism for communicating remotely with computer 300, such as for example, through radio frequency or wireless communication protocols, infrared devices, or even mobile communications. In such embodiments, the user may use the auxiliary device as a remote control to control the output on computer 300. For example, a user may retrieve information from the computer with the auxiliary display device, determine a feature or aspect of an application to project on a primary display device, and provide a user input to synchronize the selected output on the primary display device. In yet other embodiments of a detachable auxiliary device, the user may use the auxiliary device to be remotely notified of aspects of the applications (i.e., receiving a new e-mail) and select which aspects to display on the primary device upon redocking the auxiliary display device 305 or immediately if desired, such as for viewing by a third person presently utilizing the computer 300.

While the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention.

We claim:

1. A computer device having a primary display device, an auxiliary display device and computer-readable medium, wherein the computer readable medium has computer-executable instructions for performing steps comprising:
(a) receiving data regarding at least one aspect of at least one computer application;
(b) associating at least one command line with the at least one aspect of the at least one application;
(c) displaying an output on the auxiliary display device, wherein the output comprises a graphical representation of the at least one aspect of the at least one application received in step (a);
(d) receiving an input from a user, the input selecting at least one aspect of the at least one application displayed on the auxiliary display device; and
(e) executing the at least one associated command line, wherein at least one aspect of at least one application is displayed on the primary display.

2. The instructions of claim 1, further comprising the step of:
(f) receiving an input from a user, the input selecting at least one aspect of at least one application to display on the auxiliary display device in step (c).

3. The instructions of claim 1, further comprising the step of:
(g) receiving an input from a user, the input determining the associated at least one command line to be executed for at least one aspect of the software application in step (e).

4. The instructions of claim 1, wherein the primary display device is not active until step (e) is performed.

5. The instructions of claim 1, further comprising the step of:
(h) removing the computer from a low-energy state before step (e) is performed.

6. The instructions of claim 1, wherein the at least one application of step (a) is not in use by a user of the user computer when step (a) is performed.

7. The instructions of claim 1, wherein step (a) comprises receiving data from a plurality of applications, wherein the data relates to at least one aspect of each of the applications, and further comprising:
(i) processing the data in step (a) to produce additional data, wherein the additional data comprises information not available from a single application within the plurality of applications, and
(j) displaying the additional data produced in step (i) on the auxiliary display device, wherein the output comprises a graphical representation.

8. A computer device having a processor and a computer-readable medium, the computer device further comprising:
a primary display device configured to produce a visual output;
an auxiliary display device; the auxiliary device configured to display at least one aspect of at least one application, wherein the displaying of the at least one aspect of the at least one application is independent of the visual output of the primary display device;
at least one associated command line for the at least one aspect of the at least one application displayed on the auxiliary display device; and
means for a user of the computer device to select the at least one aspect of the at least one application.

9. The computer device of claim 8, further comprising a means for executing said at least one command line upon a user selecting at least one aspect of the at least one application, wherein the at least one associated command line is executed to display an output on the primary display device.

10. The computer device of claim 9, wherein the auxiliary display device is configured to process the at least one associated command line when the computer device is in a low-energy state.

11. The computer device of claim 9, further comprising an auxiliary processor associated with the auxiliary display device.

12. The computer device of claim 8, wherein the auxiliary display device is detachable from the computer device.

13. The computer device of 11, wherein the auxiliary display device is configured to communicate wirelessly with the computer device when it is detached.

14. The computer device of claim 8, wherein the computer readable medium has computer-executable instruction, the instructions configured to receive an input from a user selecting at least one aspect of at least one application to display on the auxiliary display device of the computer device.

15. The computer device of claim 14, wherein the computer readable medium has computer-executable instructions, the instructions further configured to receive an input from a user, the input providing at least one command line to be executed for at least one aspect of an application displayed on the auxiliary device.

16. A method for synchronizing an auxiliary display device and a primary display device, the method comprising the steps of:
(a) transmitting data regarding at least one aspect of at least one computer application to an auxiliary display device;
(b) displaying an output on the auxiliary display device, wherein the output comprises a graphical representation of the at least one aspect of the at least one application transmitted in step (a);
(c) storing at least one command line in a memory, wherein the at least one command line relates to the at least one aspect of the at least one application; and
(d) executing the at least one associated command line, wherein at least one aspect of at least one application is displayed on a primary display.

17. The method of claim 16, further comprising the step of:
(e) receiving an input from a user, the input selecting at least one aspect of the at least one application displayed on the auxiliary display device, wherein step (d) will execute the at least one associated command line.

18. The method of claim 16, wherein the at least one application of step (a) is not in use by a user of the user computer when step (a) is performed.

19. The method of claim 16, further comprising the step of:
(f) receiving an input from a user, the input selecting at least one aspect of at least one application to be transmitted in step (a).

20. The method of claim 16, further comprising the step of:
(g) receiving an input from a user, the input determining the associated at least one command line to be executed for at least one aspect of the software application transmitted in step (a).
